(19) United States
(12) Patent Application Publication
(10) Pub. No.: US 2026/0034942 A1
(43) Pub. Date: Feb. 5, 2026

(54) VEHICLE VALUABLES THEFT PREVENTION SYSTEM

(71) Applicant: SUBARU CORPORATION, Tokyo (JP)

(72) Inventor: Yusuke OTSUKA, Tokyo (JP)

(21) Appl. No.: 19/235,782

(22) Filed: Jun. 12, 2025

(30) Foreign Application Priority Data
Aug. 1, 2024 (JP) 2024-126208

(51) Int. Cl. B60R 7/04; B60N 2/00; B60N 2/06

(52) U.S. Cl. CPC B60R 7/043; B60N 2/0024; B60N 2/06

(57) ABSTRACT

A vehicle valuables theft prevention system includes a seat, a slide mechanism, a drive source, a valuables box, and a control unit. An occupant is to sit on the seat. The slide mechanism is provided on a vehicle body floor and configured to slidably move the seat forward and backward. The drive source is configured to drive the seat forward and backward. The valuables box is disposed under the seat and on the vehicle body floor. The control unit is configured to control driving of the drive source. For drive control of the drive source, the control unit has a first mode to regulate slide movement of the seat simply within a range where the valuables box overlaps and is hidden by the seat, and a second mode to make the seat slidably movable to a position where the valuables box is exposed.

### CROSS-REFERENCE TO RELATED APPLICATIONS

The present application claims priority from Japanese Patent Application No. 2024-126208 filed on Aug. 1, 2024, the entire contents of which are hereby incorporated by reference.

### BACKGROUND

The disclosure relates to a vehicle valuables theft prevention system mounted in a vehicle.

Vehicles such as automobiles are provided with multiple storage compartments. The storage compartments inside the vehicle, such as the glove box under the dashboard, the console box in the armrest, and door pockets, are well known. Also, for example, Japanese Unexamined Patent Application Publication No. 2010-149823 discloses an undertray, which serves as a storage compartment, slidably provided under the seat cushion.

### SUMMARY

An aspect of the disclosure provides a vehicle valuables theft prevention system including a seat, a slide mechanism, a drive source, a valuables box, and a control unit. An occupant is to sit on the seat. The slide mechanism is provided on a vehicle body floor and configured to slidably move the seat forward and backward. The drive source is configured to drive the seat forward and backward. The valuables box is disposed under the seat and on the vehicle body floor. The control unit is configured to control driving of the drive source. For drive control of the drive source the control unit has a first mode to regulate slide movement of the seat simply within a range where the valuables box overlaps and is hidden by the seat, and a second mode to make the seat slidably movable to a position where the valuables box is exposed.

An aspect of the disclosure provides a vehicle valuables theft prevention system including a seat, a slide mechanism, a drive source, a valuables box, and circuitry. An occupant is to sit on the seat. The slide mechanism is provided on a vehicle body floor and configured to slidably move the seat forward and backward. The drive source is configured to drive the seat forward and backward. The valuables box is disposed under the seat and on the vehicle body floor. The circuitry is configured to control driving of the drive source. For drive control of the drive source, the circuitry has a first mode to regulate slide movement of the seat simply within a range where the valuables box overlaps and is hidden by the seat, and a second mode to make the seat slidably movable to a position where the valuables box is exposed.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating an overview of a driver seated in a seat and a vehicle valuables theft prevention system;

FIG. 2 is a diagram illustrating a first maximum forward movement position of the seat;

FIG. 3 is a diagram illustrating a second maximum forward movement position of the seat;

FIG. 4 is a diagram illustrating a first maximum rearward movement position of the seat;

FIG. 5 is a diagram illustrating a second maximum rearward movement position of the seat;

FIG. 6 is a diagram illustrating the configuration of a valuables box with a lid that opens and closes;

FIG. 7 is a diagram illustrating the configuration of a valuables box with a lid that slides;

FIG. 8 is a flowchart of the initial setup of a valuables storage and retrieval mode by the driver; and

FIG. 9 is a flowchart illustrating an example of control executed by a control unit of the vehicle valuables theft prevention system.

### DETAILED DESCRIPTION

Conventional vehicles often do not have a lockable storage compartment, posing a risk that valuables stored in the vehicle's storage space may be stolen in the event of a break-in. Additionally, conventional vehicles, even when equipped with a lockable glove box, have faced the issue of the lock being easily pried open.

Accordingly, the disclosure has been made in view of the above circumstances, and it is desirable to provide a vehicle valuables theft prevention system that prevents the theft of valuables stored in the vehicle's storage space.

An embodiment of an in-vehicle valuables theft prevention system according to one aspect of the disclosure will now be described with reference to the drawings. Note that, in the drawings used in the following description, the scales are varied for each component to ensure that each component is recognizable in the drawings. Accordingly, the disclosure is not limited to the number of components, the shapes of the components, the size ratios of the components, or the relative positional relationships of the components as illustrated in these drawings.

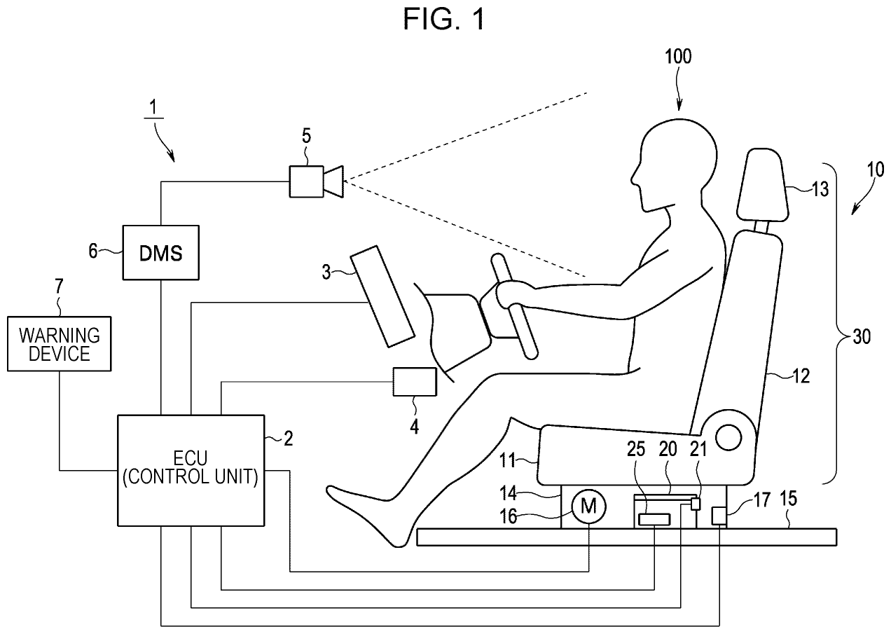

A vehicle valuables theft prevention system 1 illustrated in FIG. 1 has a control unit (hereinafter referred to as an electronic control unit (ECU)) 2, an information display 3, a user authentication device 4, a camera 5, a driver monitoring system (hereinafter referred to as DMS) 6, a warning device 7, a seat unit 10, and a valuables box 20.

The ECU 2 is electrically coupled to the information display 3, the user authentication device 4, the DMS 6, the warning device 7, the seat unit 10, and the valuables box 20. Note that the ECU 2 is composed of a microcomputer equipped with a central processing unit (CPU), read-only memory (ROM), random-access memory (RAM), and a non-volatile storage unit. The ROM stores control programs for implementing operations set for each system, fixed data, and the like.

The information display 3 has various forms and is applicable to any form. Note that operations for various settings displayed on the information display 3 are configured to be enterable with touchscreen operations. The information display 3 includes, for example, a multi-information display provided in the instrument panel, which displays not only instruments such as a speedometer and a tachometer displaying the engine's revolutions per minute (RPM), but also information related to fuel efficiency and various driving-related information.

Furthermore, the information display 3 constitutes a user setting device that includes, for example, a multi-function display provided above the central part of the dashboard, which displays basic screens such as car navigation, date, time, and fuel efficiency, as well as enables customization of various items such as the settings of the DMS 6. The user setting device also includes a center information display provided in the audio space located below the central part of the dashboard.

The user authentication device 4 is a biometric authentication device, such as a fingerprint authentication reader, a voice recognition device, or the like. A driver 100, who is an occupant, performs user authentication via the user authentication device 4, which enables the driver 100 to register settings for when the driver 100 is seated, such as the driving position and the angle of the side mirrors.

The DMS 6 is a biometric authentication device separate from the user authentication device 4 and is a facial recognition device for the driver 100. The DMS 6 is coupled to the camera 5, which is an imaging unit. The camera 5 is disposed approximately in the center of the dashboard, for example. Note that the camera 5 can be installed anywhere within the cabin, as long as it is disposed in a location where it is capable of capturing an image of the driver 100 seated on the seat unit 10.

The warning device 7 provides warnings through audible warnings from a speaker, warning lights around the meters on the instrument panel, and visual warnings displayed on the information display 3 or the navigation system monitor.

The seat unit 10 has a seat cushion 11, a seat back 12, a headrest 13, and a seat base 14. The seat cushion 11, the seat back 12, the headrest 13, and the seat base 14 together constitute a seat 30, which in this case is the driver's seat.

The seat cushion 11 constitutes a seating part on which the occupant (driver) 100 sits. The seat back 12 constitutes a backrest against which the occupant 100 leans. The headrest 13 is configured to be height-adjustable to support the head of the occupant 100.

The seat base 14 is a frame provided beneath the seat cushion 11. The seat base 14 is disposed on the floor panel, which is the vehicle body floor. The seat base 14 then constitutes a support frame that supports the seat cushion 11 from below.

The seat 30, which consists of the seat cushion 11, the seat back 12, and the headrest 13, is adjustable in position in the vehicle's front-rear direction to accommodate the occupant 100's physique and driving position. A slide mechanism 15, which is fixed to the floor panel, is provided so that the seat base 14 is slidably disposed.

The slide mechanism 15 has a lower rail, which is fixed to the floor panel, and a slider. The lower rail extends in the vehicle's front-rear direction. The slide mechanism 15 allows the seat 30 to slidably move forward and backward.

Note that the seat base 14 beneath the seat cushion 11 is provided with a slide motor 16, which is a drive source. This slide motor 16 is coupled to the ECU 2. The driving of the slide motor 16 is controlled by the ECU 2.

The seat 30 slides forward and backward relative to the lower rail of the slide mechanism 15 through the rotation of the slide motor 16. That is, the seat 30 is a so-called electric power seat that slidably moves by a slide adjustment operation of a power seat switch, which is not illustrated.

Note that the seat 30 is configured not only with the slide mechanism but also with a well-known front vertical mechanism, a lifter mechanism, a reclining mechanism, and a lumbar support adjustment mechanism.

A power seat switch and a seat memory switch, which are not illustrated, are provided on the side of the seat cushion 11, the door trim upper, and the like. By operating these switches, the driver 100 can register a desired driving position in the seat memory switch in advance and vary the position of the seat 30 electrically.

The seat base 14 is provided with a seat position detection sensor 17. The seat position detection sensor 17 is coupled to the ECU 2. The seat position detection sensor 17 detects the position in the front-rear direction of the seat 30 and outputs a detection signal to the ECU 2.

Here, the maximum slide position of the seat 30 in the vehicle valuables theft prevention system 1 will be described in detail below.

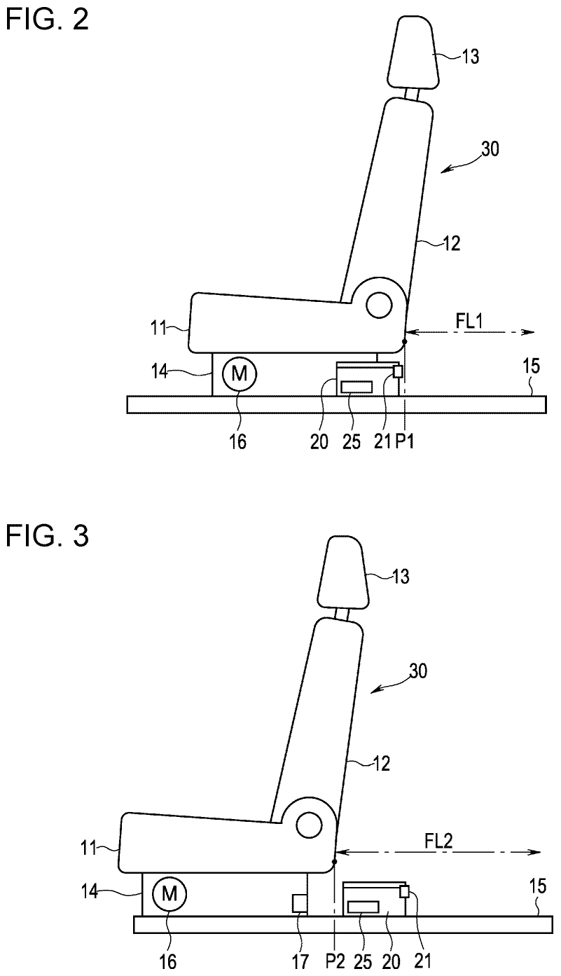

The vehicle valuables theft prevention system 1 defines, at the maximum forward slide position of the seat 30, movement to a first maximum forward movement position P1, as illustrated in FIG. 2, and a second maximum forward movement position P2, as illustrated in FIG. 3.

The first maximum forward movement position P1 of the seat 30 is the position where the valuables box 20 hides under the seat cushion 11 of the seat 30. That is, the seat 30 at the first maximum forward movement position P1 is at the position where the seat cushion 11 overlaps with the valuables box 20. Here, the seat 30 is movable simply within the range of a first slide distance FL1.

The second maximum forward movement position P2 of the seat 30 is the position where the seat cushion 11 of the seat 30 moves forward past the valuables box 20, exposing the valuables box 20. That is, the seat 30 at the second maximum forward movement position P2 is at the position where the seat cushion 11 does not overlap with the valuables box 20. Here, the seat 30 is movable within the range of a second slide distance FL2, which is longer than the first slide distance FL1.

The vehicle valuables theft prevention system 1 has a first mode that defines that the maximum forward slide position of the seat 30 can just move up to the first maximum forward movement position P1. In this first mode, even when the seat 30 is slid maximally forward, the valuables box 20 remains hidden under the seat cushion 11 of the seat 30.

Therefore, the first mode is a normal seat movement mode, which is a theft prevention storage box unopenable mode where the valuables box 20 cannot be accessed.

In addition, the vehicle valuables theft prevention system 1 has a second mode that defines that the maximum forward slide position of the seat 30 can move up to the second maximum forward movement position P2. In this second mode, when the seat 30 is slid maximally forward, the valuables box 20 is exposed behind the seat cushion 11.

Therefore, the second mode is a valuables storage and retrieval mode, which is a storage box open/close mode that allows access to the valuables box 20.

Note that the ECU 2 receives the position of the seat 30 detected by the seat position detection sensor 17. Then, depending on whether the first mode or the second mode is selected, the ECU 2 controls the driving of the slide motor 16 to slide and drive the seat 30 forward, up to the first maximum forward movement position P1 or the second maximum forward movement position P2.

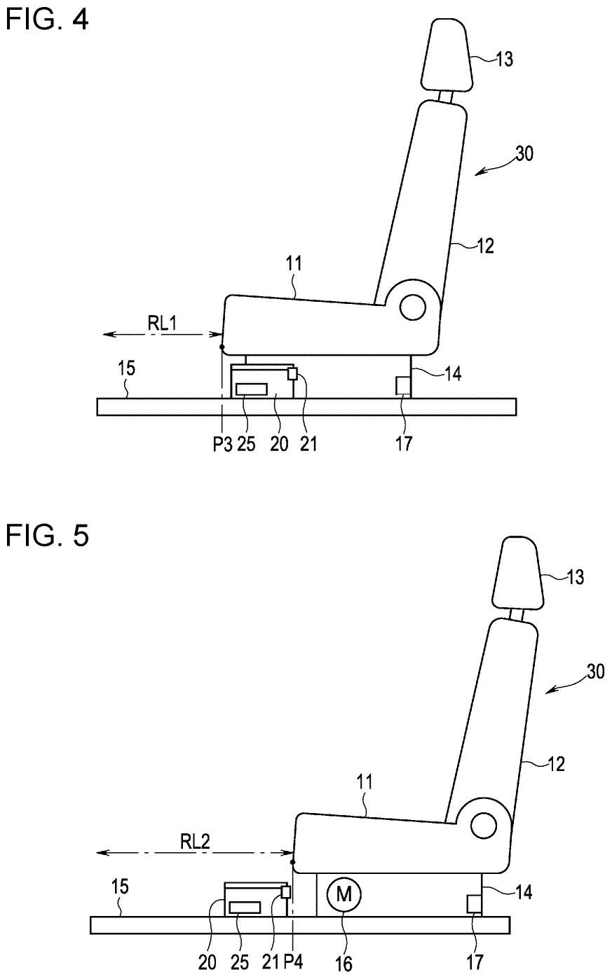

Additionally, the vehicle valuables theft prevention system 1 may be configured to define, at the maximum rearward slide position of the seat 30, movement to a first maximum rearward movement position P3, as illustrated in FIG. 4, and a second maximum rearward movement position P4, as illustrated in FIG. 5.

The first maximum rearward movement position P3 of the seat 30 is the position where the valuables box 20 hides under the seat cushion 11 of the seat 30. That is, the seat 30 at the first maximum rearward movement position P3 is at the position where the seat cushion 11 overlaps with the valuables box 20. Here, the seat 30 is movable simply within the range of a third slide distance RL1.

The second maximum rearward movement position P4 of the seat 30 is the position where the seat cushion 11 of the seat 30 moves rearward past the valuables box 20, exposing the valuables box 20. That is, the seat 30 at the second maximum rearward movement position P4 is at the position where the seat cushion 11 does not overlap with the valuables box 20. Here, the seat 30 is movable within the range of a fourth slide distance RL2, which is longer than the third slide distance RL1.

The vehicle valuables theft prevention system 1 has a third mode that defines that the maximum rearward slide position of the seat 30 can just move up to the first maximum rearward movement position P3. In this third mode, even when the seat 30 is maximally slid rearward, the valuables box 20 remains hidden under the seat cushion 11 of the seat 30. Therefore, the third mode is a normal seat movement mode, which is a theft prevention storage box unopenable mode where the valuables box 20 cannot be accessed.

In addition, the vehicle valuables theft prevention system 1 has a fourth mode that defines that the maximum rearward slide position of the seat 30 can move up to the second maximum rearward movement position P4. In this fourth mode, when the seat 30 is slid maximally rearward, the valuables box 20 is exposed in front of the seat cushion 11.

Therefore, the fourth mode is a valuables storage and retrieval mode, which is a storage box open/close mode that allows access to the valuables box 20.

Note that the ECU 2 receives the position of the seat 30 detected by the seat position detection sensor 17. Then, depending on whether the third mode or the fourth mode is selected, the ECU 2 controls the driving of the slide motor 16 to slide and drive the seat 30 rearward, up to the first maximum rearward movement position P3 or the second maximum rearward movement position P4.

Note that the vehicle valuables theft prevention system 1 may define the seat 30's maximum movement to, in addition to the first maximum forward movement position P1 and the second maximum forward movement position P2, the first maximum rearward movement position P3 and the second maximum rearward movement position P4.

Furthermore, the ECU 2 may detect the first maximum forward movement position P1, the second maximum forward movement position P2, the first maximum rearward movement position P3, and the second maximum rearward movement position P4 of the seat 30 based on the number of rotations of the slide motor 16.

Next, the configuration of the valuables box 20 will be described in detail below.

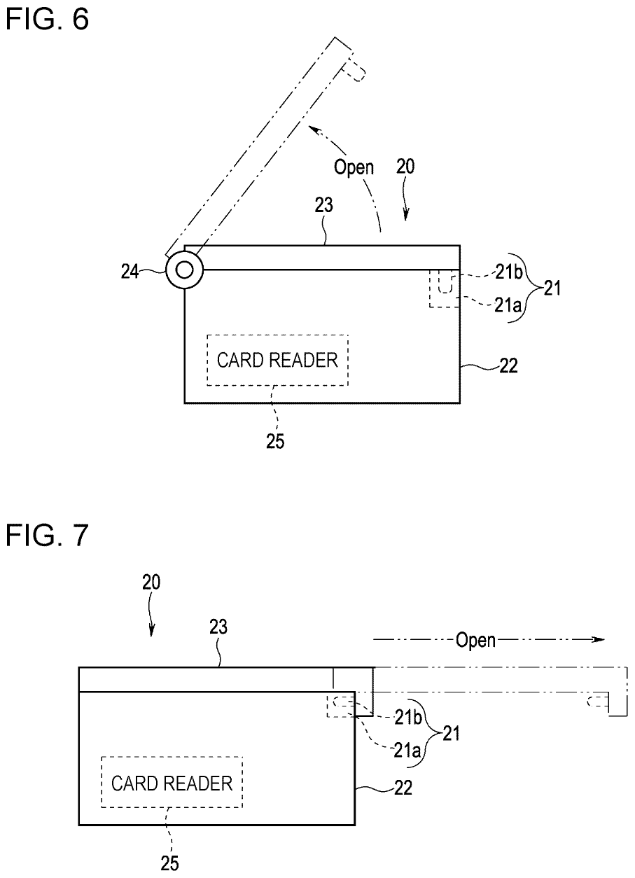

The valuables box 20 is secured to the floor panel of the vehicle body. As illustrated in FIG. 6, the valuables box 20 has a box-shaped storage compartment 22 with an open top and a lid 23 that serves as a cover to close the opening of the storage compartment 22.

A card reader 25 is mounted within the storage compartment 22. This card reader 25 is an in-vehicle device into which a card for an electronic toll collection system, referred to as an Electronic Toll Collection (ETC) card in Japan, serving as a valuable item, is inserted to read the card information, and this device is called an ETC in-vehicle device.

Note that the card reader 25 is coupled to the ECU 2, and wirelessly communicates the card information, which is necessary for toll payment, to an antenna installed at a toll station via a vehicle antenna (not illustrated) coupled to the ECU 2.

The storage compartment 22 and the lid 23 are provided with an electronic lock 21. The electronic lock 21 is composed of, for example, an electronic lock actuator 21a and a striker 21b. Here, the electronic lock actuator 21a is provided on the storage compartment 22 side.

The electronic lock actuator 21a is electrically coupled to the ECU 2. The driving of the electronic lock actuator 21a is controlled by the ECU 2 to lock and unlock.

Note that the lid 23 is provided with the striker 21b, which is locked by the electronic lock actuator 21a.

The ECU 2 unlocks the electronic lock 21 strictly when the seat 30 is moved to the second maximum forward movement position P2 in the second mode or to the second maximum rearward movement position P4 in the fourth mode. Additionally, the ECU 2 locks the electronic lock 21 when the seat 30 is moved from the second maximum forward movement position P2 or the second maximum rearward movement position P4. Alternatively, the valuables box 20 may be configured with a cylinder lock that locks and unlocks the lid 23 to the storage compartment 22 using a key.

As illustrated in FIG. 6, the lid 23 of the valuables box 20 is configured to open and close relative to the storage compartment 22 by a pivot point of a hinge mechanism 24. Note that, as illustrated in FIG. 7, the lid 23 may be slid relative to the storage compartment 22.

The vehicle valuables theft prevention system 1 configured as described above has the first mode and the third mode, which correspond to the normal seat movement mode, in which the valuables box 20 cannot be opened or closed, according to the slide position of the seat 30. The vehicle valuables theft prevention system 1 also has the second mode or the fourth mode, which correspond to the valuables storage and retrieval mode in which the valuables box 20 can be opened and closed.

Note that, if the vehicle valuables theft prevention system 1 is not in the valuables storage and retrieval mode, the normal seat movement mode is set as the default. Additionally, the vehicle valuables theft prevention system 1 sets the valuables storage and retrieval mode in response to the driver 100's operation on the information display 3.

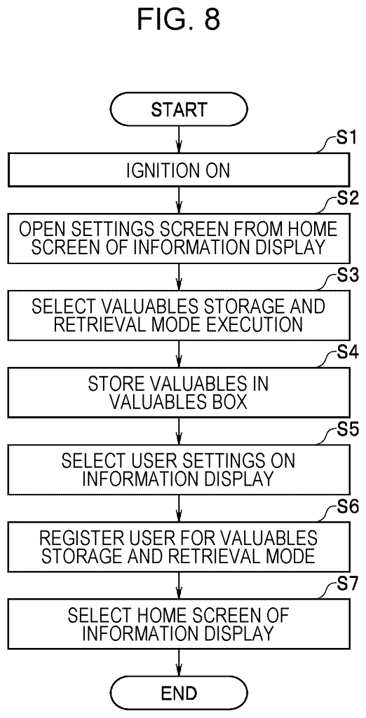

Here, the user settings and access to the valuables box 20 during the initial setup for executing the vehicle valuables theft prevention system 1 by the driver 100 will be explained below, based on the flowchart in FIG. 8.

As illustrated in FIG. 8, the driver 100 turns on the ignition (S1). The driver 100 then opens the settings screen from the home screen of the information display 3 (S2).

At this time, the driver 100 opens the settings screen of the information display 3 through a touchscreen operation on the information display 3. The driver 100 then selects the valuables storage and retrieval mode execution (S3).

In response to selection of the valuables storage and retrieval mode execution, the vehicle valuables theft prevention system 1 sets the second mode as the default, which slidably moves the seat 30 to the second maximum forward movement position P2.

Note that the driver 100 may be able to specify the second mode or the fourth mode when the valuables storage and retrieval mode execution is selected. That is, the driver 100 may be able to selectively specify the second mode, which slidably moves the seat 30 to the second maximum forward movement position P2, or the fourth mode, which slidably moves the seat 30 to the second maximum rearward movement position P4.

At this time, the vehicle valuables theft prevention system 1 slidably moves the seat 30 to the second maximum forward movement position P2 or the second maximum rearward movement position P4 through the drive control of the slide motor 16 by the ECU 2.

Note that the ECU 2 stops the driving of the slide motor 16 when the seat 30 reaches the second maximum forward movement position P2 or the second maximum rearward movement position P4, based on the detection signal of the seat position detection sensor 17. The ECU 2 then unlocks the electronic lock 21.

The driver 100 opens the lid 23 of the valuables box 20, allowing storage of valuables or the like in the storage compartment 22 (S4). Next, the driver 100 selects user settings through a touchscreen operation on the information display 3 (S5), and performs user registration for the valuables storage and retrieval mode (S6).

User registration is conducted when the driver 100 performs authentication using the user authentication device 4, which includes fingerprint recognition, voice recognition using a voice recognition device, facial recognition via the DMS 6, or entering a PIN through a touchscreen operation on the information display 3. Note that the driver 100's user registration may allow for selective combinations of fingerprint recognition, voice recognition using a voice recognition device, facial recognition, or PIN registration.

Upon completion of the user registration, the driver 100 selects the home screen through a touchscreen operation on the information display 3 (S7). In this way, the vehicle valuables theft prevention system 1 executes the valuables storage and retrieval mode. Note that the information display 3 may automatically return to the home screen with the completion of the user registration in the valuables storage and retrieval mode.

Additionally, upon returning to the home screen, the vehicle valuables theft prevention system 1 may return the seat 30 to its original position upon turning on the ignition through the drive control of the slide motor 16 by the ECU 2. Note that the driver 100 may move the seat 30 to the desired position by themselves using the power seat switch and seat memory switch.

Furthermore, the user registration for the valuables storage and retrieval mode can be performed not only by the driver 100 but also by other occupants. In addition, it is preferable that cancellation of the user registration for the valuables storage and retrieval mode be performed strictly by the last registered user.

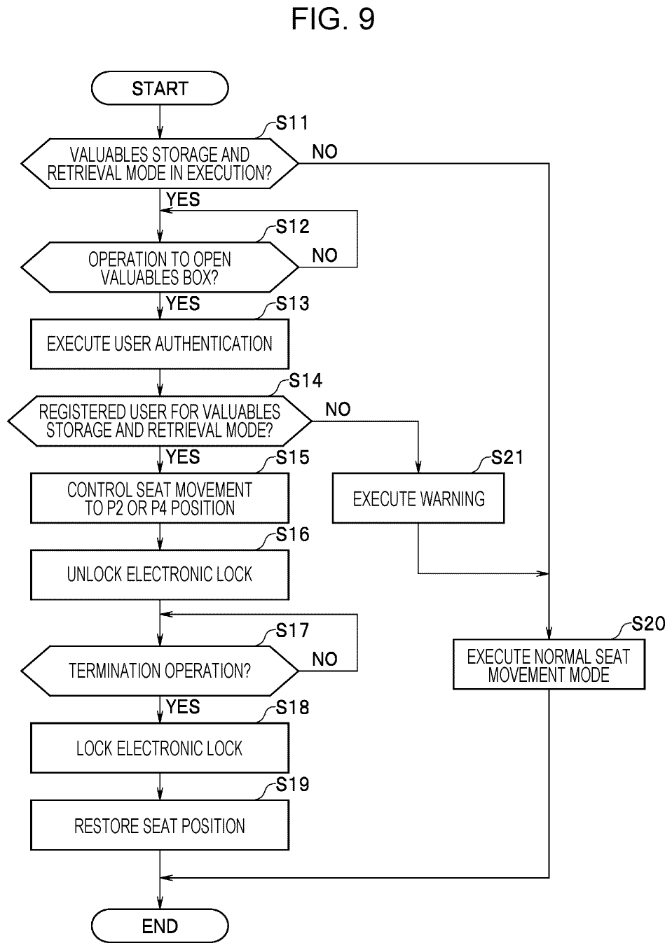

Next, an example of control executed by the ECU 2 of the vehicle valuables theft prevention system 1 will be described below, based on the flowchart illustrated in FIG. 9.

The ECU 2 of the valuables theft prevention system 1 determines whether the valuables storage and retrieval mode is being executed (S11).

If the valuables storage and retrieval mode is not being executed (step S11: NO), the ECU 2 executes the normal seat movement mode (S20). That is, the seat 30 is regulated so that it can just slidably move forward and backward between the first maximum forward movement position P1 and the first maximum rearward movement position P3.

This allows the vehicle valuables theft prevention system 1 to prevent the valuables box 20 from being exposed even if the seat 30 is moved maximally forward and backward. Note that this normal seat movement mode is executed as the theft prevention storage box unopenable mode, where the valuables box 20 cannot be accessed.

If the valuables storage and retrieval mode is being executed (step S11: YES), the ECU 2 determines whether an operation to open the valuables box 20 has been detected (S12). If no operation to open the valuables box 20 is detected (step S12: NO), the ECU 2 repeatedly executes this determination routine in step S12.

Note that an operation to open the valuables box 20 is performed by the driver 100, for example, through a touchscreen operation on the information display 3. At this time, the ECU 2 receives an open signal of the valuables box 20 from the information display 3. Additionally, an operation to open the valuables box 20 may be performed through a smart key operation.

In response to detection of an operation to open the valuables box 20 (step S12: YES), the ECU 2 performs user authentication (S13). Then, the ECU 2 determines whether the user is a registered user for the valuables storage and retrieval mode (S14).

At this time, the ECU 2 executes user authentication based on the driver 100's fingerprint recognition using the user authentication device 4, voice recognition using a voice recognition device, facial recognition via the DMS 6, or input information of a PIN through a touchscreen operation on the information display 3.

If the user is not a registered user for the valuables storage and retrieval mode (step S14: NO), the ECU 2 executes a warning (S21). The ECU 2 provides alerts through the warning device 7 at a predetermined time, including audible warnings from a speaker, warning lights around the meters on the instrument panel, and visual warnings displayed on the information display 3 or the navigation system monitor.

The ECU 2 then executes the normal seat movement mode described above (S20). This allows the vehicle valuables theft prevention system 1 to prevent the valuables box 20 from being exposed and accessed even if the seat 30 is moved maximally forward and backward.

If the user is a registered user for the valuables storage and retrieval mode (step S14: YES), the ECU 2 automatically slidably moves the seat 30 to the second maximum forward movement position P2 or the second maximum rearward movement position P4 (S15).

The ECU 2 controls the driving of the slide motor 16 to slidably move the seat 30 maximally forward or rearward to the second maximum rearward movement position P2 or the second maximum rearward movement position P4. Note that the ECU 2 moves the seat 30 to the second maximum forward movement position P2 or the second maximum rearward movement position P4 specified in advance by the driver 100 during the initial setup.

The ECU 2 then unlocks the electronic lock 21 (S16). In this way, the vehicle valuables theft prevention system 1 moves the seat 30 to the position (P2 or P4) where the valuables box 20 is exposed, allowing the driver 100 to open the lid 23 of the valuables box 20 to access the storage compartment 22. This allows the driver 100 to store or retrieve valuables or the like in or from the storage compartment 22.

The ECU 2 determines whether a termination operation has been entered (S17). If no termination operation is entered (step S17: NO), the ECU 2 repeats the determination routine in step S17.

The termination operation is performed by the driver 100 when the lid 23 of the valuables box 20 is closed, for example, through a touchscreen operation on the information display 3. Note that the ECU 2 may recognize the termination operation when the driver 100 operates the power seat switch and the seat memory switch.

If the termination operation is entered (step S17: YES), the ECU 2 locks the electronic lock 21 (S18). In this way, the lid 23 of the valuables box 20 is locked to the storage compartment 22.

The ECU 2 restores the position of the seat 30 (S19) and terminates this control. Note that the ECU 2 controls the driving of the slide motor 16 to slidably move the seat 30 to its original position, which is prior to the operation to open the valuables box 20 in step S12, for example.

As described above, the vehicle valuables theft prevention system 1 of the present embodiment is configured with the valuables box 20 disposed under the seat cushion 11 of the seat 30, and the vehicle valuables theft prevention system 1 has, according to the seat 30's slide position, the normal seat movement mode where the valuables box 20 cannot be opened or closed, and the valuables storage and retrieval mode where the valuable box 20 can be opened and closed.

The vehicle valuables theft prevention system 1 is configured to control the position of the seat 30 to slidably move forward and backward simply within the range where the valuables box 20 remains hidden under the seat cushion 11 of the seat 30 in the normal seat movement mode.

Additionally, the vehicle valuables theft prevention system 1 is configured to allow the seat 30 to slidably move forward and backward to a position where the valuables box 20 is exposed, by moving the seat cushion 11 of the seat 30 forward or rearward past the valuables box 20, based on the authentication of a registered user, who is the driver 100 in the above description, in the valuables storage and retrieval mode.

Therefore, the vehicle valuables theft prevention system 1 ensures that, even in the event of a break-in, access to the valuables box 20, which is the in-vehicle valuables storage compartment, is not possible unless the person is authenticated as a user registered in the valuables storage and retrieval mode. That is, the vehicle valuables theft prevention system 1 prevents the valuables inside the valuables box 20 from being stolen because the seat 30 can simply slidably move forward and backward within the range where the valuables box 20 remains hidden under the seat cushion 11 of the seat 30.

Note that the control unit (ECU) 2 has a processor including a central processing unit (CPU) and a storage device such as ROM, RAM, etc. Additionally, all or some of the configurations of multiple circuits of the processor may be executed by software. For example, the CPU may read and execute various programs corresponding to the individual functions stored in the ROM.

Furthermore, all or some of the functions of the processor may be composed of logic circuits or analog circuits, and the processing of various programs may be implemented by electronic circuits such as field-programmable gate arrays (FPGAs).

The disclosure described in the above embodiment is not limited to the embodiment, and various modifications can be implemented within the scope without departing from its spirit at the implementation stage. Furthermore, the above-described embodiment includes techniques of the disclosure at various stages, and various techniques of the disclosure can be extracted by appropriately combining multiple components disclosed.

For example, if several components are removed from all the components discussed in the embodiment, and the stated issues can still be solved and the stated effects can still be achieved, then the configuration without these removed components may be extracted as techniques of the disclosure.

According to the disclosure, a vehicle valuables theft prevention system that prevents the theft of valuables stored in the vehicle's storage space can be provided.

The control unit (ECU) 1 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control unit (ECU) 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle valuables theft prevention system comprising:
a seat on which an occupant is to sit;
a slide mechanism provided on a vehicle body floor and configured to slidably move the seat forward and backward;
a drive source configured to drive the seat forward and backward;
a valuables box disposed under the seat and on the vehicle body floor; and
a control unit configured to control driving of the drive source,
wherein, for drive control of the drive source, the control unit has a first mode to regulate slide movement of the seat simply within a range where the valuables box overlaps and is hidden by the seat, and a second mode to make the seat slidably movable to a position where the valuables box is exposed.

2. The vehicle valuables theft prevention system according to claim 1, wherein the control unit is configured to control driving of the drive source such that, in the first mode, the seat moves to a maximum forward or rearward movement position where the valuables box and a seat cushion of the seat overlap, and, in the second mode, the seat moves to either a maximum forward or rearward movement position where the seat cushion moves forward or rearward past the valuables box.

3. The vehicle valuables theft prevention system according to claim 1, further comprising:
a user setting device coupled to the control unit and configured to register a user who executes the second mode; and
a user authentication device coupled to the control unit and configured to authenticate the user who has been registered,
wherein the control unit is configured to, upon the user authentication device authenticating the user during execution of the second mode, control driving of the drive source to move the seat to a position where the valuables box is exposed.

4. The vehicle valuables theft prevention system according to claim 2, further comprising:
a user setting device coupled to the control unit and configured to register a user who executes the second mode; and
a user authentication device coupled to the control unit and configured to authenticate the user who has been registered,
wherein the control unit is configured to, upon the user authentication device authenticating the user during execution of the second mode, control the driving of the drive source to move the seat to a position where the valuables box is exposed.

5. The vehicle valuables theft prevention system according to claim 3, wherein:
the valuables box comprises an electronic lock coupled to the control unit; and
the control unit is configured to unlock the electronic lock when the seat moves to a position where the valuables box is exposed.

6. The vehicle valuables theft prevention system according to claim 4, wherein:
the valuables box comprises an electronic lock coupled to the control unit; and
the control unit is configured to unlock the electronic lock when the seat moves to a position where the valuables box is exposed.

7. The vehicle valuables theft prevention system according to claim 3, further comprising an in-vehicle device, provided in the valuables box, for an electronic toll collection system.

8. The vehicle valuables theft prevention system according to claim 4, further comprising an in-vehicle device, provided in the valuables box, for an electronic toll collection system.

9. A vehicle valuables theft prevention system comprising:
a seat on which an occupant is to sit;
a slide mechanism provided on a vehicle body floor and configured to slidably move the seat forward and backward;
a drive source configured to drive the seat forward and backward;
a valuables box disposed under the seat and on the vehicle body floor; and
circuitry configured to control driving of the drive source,
wherein, for drive control of the drive source, the circuitry has a first mode to regulate slide movement of the seat simply within a range where the valuables box overlaps and is hidden by the seat, and a second mode to make the seat slidably movable to a position where the valuables box is exposed.
